(19) United States
(12) Patent Application Publication
(10) Pub. No.: US 2014/0018034 A1
(43) Pub. Date: Jan. 16, 2014

(54) Apparatus, System and Method for Modifiable Observational Logic for Mobile Terminal Data Analysis and Distribution

(71) Applicant: Arbitron Mobile Oy, Espoo (FI)

(72) Inventor: Tero Lindberg, Espoo (FI)

(73) Assignee: Arbitron Mobile Oy, Espoo (FI)

(21) Appl. No.: 14/024,794

(22) Filed: Sep. 12, 2013

Related U.S. Application Data
(63) Continuation-in-part of application No. 13/722,163, filed on Dec. 20, 2012.
Application No. 13/722,163 is a continuation-in-part of application No. 13/001,492, filed on Dec. 27, 2010.

(51) Int. Cl. H04W 24/00

(52) U.S. Cl. CPC H04W 24/00
USPC 455/405

(57) ABSTRACT

Apparatus, system and method for modifying observational logic for mobile terminal device data analysis. As new data is observed under a first data observation parameter, a determination is made whether temporary settings are enabled to allow a data handling agent/logic to modify observational parameters. Temporary settings may be configured to collect certain data over a predetermined period of time and/or may be disabled on the occurrence of a particular event or status. Once temporary settings are detected, the device opens and applies those settings from observation modification software and collects device data using the temporary setting(s). Once the temporary settings are disabled, the original settings are restored where data is then collected under the original settings until new data is observed or the collection process ends.

### RELATED APPLICATIONS

The present application is a continuation-in-part of U.S. non-provisional patent application Ser. No. 13/722,163 titled “Apparatus, System and Method for Mobile Terminal Data Analysis and Distribution Utilizing Internal Proxies” which is a continuation-in-part of U.S. non-provisional patent application Ser. No. 13/001,492 filed on Dec. 27, 2010 titled “Mobile Terminal and Method for Providing Life Observations and a Related Server Arrangement and Method With Data Analysis, Distribution and Terminal Guiding,” which claims priority to PCT/FI2009/050186 filed on Mar. 9, 2009. Each of these is hereby incorporated herein by reference in its entirety.

### TECHNICAL FIELD

The present disclosure generally relates to mobile devices and communications networks. In particular the disclosure is directed to monitoring one or more mobile terminals using internal proxies and processing and distributing the related data through customized interfaces utilizing cumulative and centralized intelligence for data handling.

### BACKGROUND INFORMATION

There has been considerable interest in monitoring the use of mobile terminals for audience measurement and/or marketing purposes. Using software and/or hardware solutions, characteristics of device usage, and media/application exposure and use may be effectively monitored. Technologies such as GPS (Global Positioning System) have also been utilized for locating and consensually tracking people through a mobile device. Items such as photographs, social media, and/or micro-blog entries via the web have been utilized for various tools built for smart phones that provide “add-on” application monitoring capabilities. It is apparent that mobile phones or “smart phones” will emerge as a dominant digital device that people will carry with them and use on a daily basis. Smart phones will function as communication devices, authentication tools, digital wallets and keys, etc. Smart phones could also be exploited as “always-on” observers as well. Smart phone devices are possibly in the best position to become universal digital observers, being able to track locations, temperatures, movements, communication activities, proximity to other people, social interactions, etc. There is no strict limit with regard to the possible observations as various kinds of observers and sensors may be included in the smart phones. For example, in the future the smart phones might collect a rich feed of data containing comprehensive audio and video recordings relative to each day, and thus let the people generate a digital storage of their activities.

Data that can be collected in a smart phone can naturally be used locally in the same device. For instance, temperature data can be shown on the screen of the phone. However, some data may be at least occasionally worth sending to other people, for example the current location of the device might form a useful piece of information for other people considering e.g. different “buddy tracking” purposes. One drawback associated with the contemporary solutions is that they typically implement straightforward end-to-end pipelines more or less focusing on certain kinds of data items only. In addition, the users may have to manually enable or conduct the data acquisition phase and even perform dedicated follow-up actions such as sending the data by specifically selecting an update feature of the relevant application.

A number of prior art arrangements propose to collect data points, position the user, or to make contextual data points locally available to other applications of the particular phone. For example, prior art publication WO2008/118119, incorporated by reference herein, discloses a mobile device and a method for communicating positioning data of the mobile device to a server at a periodic interval, then automatically generating in the mobile device, in response to the server, a present location profile associated with a present geographic location of the mobile device, simultaneously generating, in the mobile device, a set of adjacent profiles provided by the server as being a direction away from the present geographic location of the mobile device, and refreshing in the mobile device, the present location profile and the set of adjacent profiles at the periodic interval.

### BRIEF SUMMARY

The techniques and arrangements in the present disclosure alleviate at least some of the drawbacks of the prior art solutions and provide a more intelligent, flexible and adaptive alternative for monitoring characteristics and use of mobile devices. Under one embodiment, a mobile terminal and a service arrangement is arranged in a bi-centralized manner, in which one or more mobile terminals may automatically collect a considerable amount of behavioral, technical and contextual data (i.e. observation data) and further automatically transmit at least part of the gathered data to one or more servers at the optimal time instant. Alternately, mobile terminals may also receive contextual intelligence from the server(s) to be used in the mobile devices for data acquisition. The server side is preferably made primarily responsible for managing the cumulative intelligence, linkage between one specific device and other devices, external environment, and/or historical data. The embodiments disclosed herein may be implemented as software architecture on a tangible medium for automatically conducting triggered observations in a mobile terminal and optimally converting these observations into feed data, which can be further processed and enriched with a centralized server-side software component and provided to external systems via a standardized data distribution interface. Such a configuration for collecting, transmitting and distributing feed data advantageously results in a more modular, smarter and flexible overall solution that makes a distinction between the layers of data collection with pre-processing (i.e. the mobile agent part arranged in the mobile terminal), and data processing with centralized intelligence and distribution facilities (i.e. the server arrangement).

As used herein, data feeds are sometimes referred to as “life feeds” and are directed to the automatic collection and processing of computer terminal data (“life data”) and enabling the transfer and distribution of this data to external entities. Life feeding may link mobile terminals to entities such as web services in an integrated manner. For example, life feeding applications may enable automatic updating of users' social networking profiles with real-time location and other data provided by the mobile terminals. A life feed may refer to all information that can be generated in response to monitoring people's everyday life, including for example data on locations, movements, activities and calendar entries. In addition to various actions and events, a life feed can also incorporate user-generated content, such as blog entries and photos. A mobile life feed may be defined as a life feed that can be generated from data provided by a mobile terminal.

An application programming interface (API) may be defined as an interface provided by one software module to other modules, typically built for the function of distributing data. An API may support, for example, queries by another system, and then supply data based on the query details. APIs also define the communications and interoperability between modules.

An agent may be defined as at least one application in a wireless device, capable of preferably seamless and automatic execution on the background (i.e., not intervening or disrupting other applications). An agent is enabled to perform operations, and communicate with the Internet, or with other applications.

Observers may be defined in this context as processes capable of generating data based on items such as queries and use of the wireless device's operating system capabilities. Observers are, in a way, sensors, which can automatically sense, for example, changes identified in a cellular base station usage (when the device jumps from the coverage of one tower to the next, for instance). Observers can also refer to channels of user-generated content such as blog entries and/or web activity.

Triggers may be defined rules and processes that cause a certain action. The present disclosure introduces novel algorithms and rules on how the observations can be done more effectively and automatically in wireless devices. Triggers can be based on time intervals, contextual changes and observations, external requests, or internal requests for example in a situation in which more data is needed for some other datapoints.

The concept of “intelligence” in this disclosure may be defined as a set of rules, algorithms, databases and/or processes on a tangible medium that coordinate the overall process, or individual micro-processes such as triggering logic. Intelligence is something that makes the system to work smarter, in a more optimal way, saving energy and improving accuracy. The intelligence can be based on fixed and/or self-learning, adaptive algorithms as well as on external input.

A server as used herein may refer to a node in one or more networks, such as the Internet. A server can serve clients, such as mobile agents running in mobile terminals. Clients may thus communicate with one or more centralized servers. Client-server architecture is a commonly used topology of building systems in the Internet.

The concept of processing as used herein may refer to various kinds of actions than be performed on data. These include data conversions, transformations, formulations, combinations, mash-ups enrichment, correlations, clustering, factoring, normalizing, and filtering, among others, and are applied differently in different situations. Some forms of processing are actively used in various embodiments, including combinations and mash-ups (linking data points together and building relational data structures), conversions (generating, for example, meaningful streams of information entities from raw-level, unsorted data items, such as observed location points), enrichment (adding meta data and making the data richer than originally) and filtering (leaving out data that is not relevant or needed anymore).

The expression “a plurality of” refers herein to any integer starting from two (2), e.g. two, three, or four. The expression “a number of” refers herein to any integer starting from one (1), e.g. one, two, or three. The expression “data transfer” may refer to transmitting data, receiving data, or both, depending on the role(s) of a particular entity under analysis relative a data transfer action, i.e. a role of a sender, role of a recipient, or both.

Under one exemplary embodiment, systems, apparatuses and methods are disclosed for dynamically altering observation data produced on a mobile terminal, comprising techniques involving configuring the mobile terminal to produce first observation data under at least one first parameter, wherein the first observation data comprises data relating to at least one of (i) a manner of usage and (ii) operating state of the mobile terminal; determining, from the first observation data, if a specific data characteristic is present; and configuring the mobile terminal to produce second observation data under at least one second parameter if the specific data characteristic is present, wherein at least one of the second parameter is different from the first parameter.

Under another exemplary embodiment, systems, apparatuses and methods are disclosed for dynamically altering observation data received from a mobile terminal, comprising techniques involving providing first software instructions for the mobile terminal for producing first observation data under at least one first parameter, wherein the first observation data comprises data relating to at least one of (i) a manner of usage and (ii) operating state of the mobile terminal, and wherein the first software instructions are configured to determine if a specific data characteristic is present in the first observation data; transmitting second software instructions for the mobile terminal, wherein the second software instructions are configured to alter the mobile terminal to produce second observation data under at least one second parameter if the specific data characteristic is present, wherein at least one of the second parameter is different from the first parameter; and receiving and processing the first and second observation data in a data handling agent.

### BRIEF DESCRIPTION OF THE DRAWINGS

The present invention is illustrated by way of example and not limitation in the figures of the accompanying drawings, in which like references indicate similar elements and in which:

FIG. 1 is an exemplary system diagram illustrating communication among mobile terminals to a computer network that is communicatively coupled to at least one server arrangement and external entities;

FIG. 2A is an exemplary mobile terminal portable computing device configured to provide monitoring capabilities on the device;

FIG. 2B is an exemplary server arrangement for receiving and processing data from a portable computing device, and for communicating with a portable computing device;

FIG. 3 is an exemplary flow diagram for communication between a mobile terminal and server arrangement under one embodiment;

FIG. 4 is an exemplary flow diagram of one embodiment of observation logic in a mobile terminal;

FIG. 5 is an exemplary flow diagram of one embodiment of a data handling agent in a mobile terminal;

FIG. 6 is an exemplary flow diagram of one embodiment of server-side analytics and data processing logic;

FIG. 7 is an exemplary flow diagram of a data distribution API under one embodiment;

FIG. 8 is an exemplary composite flow diagram of embodiments for processes performed on a mobile terminal and a server arrangement, respectively;

FIG. 9 illustrates an internal proxy arrangement for a mobile terminal under one embodiment;

FIG. 10 illustrates an exemplary process for temporarily modifying collection of observational data under another embodiment; and

FIG. 11 illustrates one exemplary process for modifying and collecting observational data using the embodiment of FIG. 10.

### DETAILED DESCRIPTION

A mobile terminal as used herein comprises at least one wireless communications transceiver. Non-limiting examples of the transceivers include a GSM (Global System for Mobile Communications) transceiver, a GPRS (General Packet Radio Service) transceiver, an EDGE (Enhanced Data rates for Global Evolution) transceiver, a UMTS (Universal Mobile Telecommunications System) transceiver, a WCDMA (wideband code division multiple access) transceiver, a PDC (Personal Digital Cellular) transceiver, a PHS (Personal Handy-phone System) transceiver, and a WLAN (Wireless LAN, wireless local area network) transceiver. The transceiver may be such that it is configured to co-operate with a predetermined communications network (infrastructure), such as the transceivers listed above. The network may further connect to other networks and provide versatile switching means for establishing circuit switched and/or packet switched connections between the two end points. Additionally, the device may include a wireless transceiver such as a Bluetooth adapter meant for peer-to-peer communication and piconet/scatternet use. Furthermore, the terminal may include interface(s) for wired connections and associated communication relative to external entities, such as an USB (Universal Serial Bus) interface or a Firewire interface.

As will be explained in further detail below, mobile terminal events may be monitored, where the events may include, for example, substantially non-user-initiated incidents such as battery status change, not at least directly initiated by the user of the device. The actions may include substantially user-initiated intentional activities and incidents, for example use of the web browser, movements, reading a message, etc. Some incidents may be also considered to conveniently fit both the above incident classes.

Embodiments of the mobile terminal further apply different triggers and preferably also smart algorithms that coordinate performing observations and/or data transmissions. For example, when the user places a voice call, this can be used to trigger an automatic observation of the location (e.g. via GPS) which may automatically trigger a poll on base station tower information, after which an automatic data transmission may take place. Consequently a server side may be provided with near to real-time knowledge about each user's recent communication activities. The triggers can be based on hard-coded known dynamics, such as base station changes (that typically reflect movements if they happen frequently), or alternatively on self-learning, adaptive logic, or both. For example, an intelligence engine for a mobile terminal may be configured to recognize patterns that occur on a regular basis, such as updating calendar entries at specific times and the like, prompting a smart rule for checking calendar content at a time interval afterwards.

Observation logic is preferably tied natively to the mobile device without using middle layer platforms, which allows for more direct observations, smarter logic, better access to platform stable process, and little intervention in other processes. It is understood that other configurations, which may include middle layer platforms, are possible as well in the present disclosure. When tied natively, observation logic is also preferably enabled to pre-process observation data on a raw-level format, which may refer to the verification of a data point's validity, dropping duplicate observations, calculating indices (averages), normalizing observations, and/or other ways making the data flow smoother, optimized (volume-wise) or more reliable. Data conversion and pre-processing part of the observation logic may also be configured to utilize feedback from remote entities, and overall intelligence, which might be linked to contextual factors as well. Thus, in one embodiment the observation logic may be configured to utilize the input by external entities such as a server. As an example, the input may comprise intelligence provided by an external entities such as weather conditions, cellular network topology, and/or activities of the social network in the form of rules, for example, whereupon the mobile terminal may be configured to apply such input to improve and update the operations of the observation logic. As a further example, a data input module and/or data handling agent may be utilized in providing the instructions, being locally generated and/or received from external entities, to the observation logic.

In any event, observation logic is preferably enabled herein to conduct active monitoring (observations), such as scanning device memory or available Bluetooth connections for data. Under this embodiment, active observations are substantially done on the basis of active triggers and consequent observations done via device APIs. Additionally, the observation logic supports passive observations, which are based on sensing an observation environment, and may be induced by change(s) in the observation environment. These changes may be traced through an operating system's APIs to a data point for subsequent storage. Low-level device interfaces can be registered accordingly so that when a change happens, an observation is recorded.

For example, upon recognizing that an active base station has changed, an associated observation can be made so that the details of the base station with all the necessary parameters (e.g., signal strength and timing advance) will be scanned. Accordingly, a related data point may be written into the log. The observation logic may collect data points based on communication actions such as initiating a call, answering a call, sending a message such as an SMS (Short Message Service), MMS (Multimedia Message Service), or e-mail message, receiving a corresponding message, etc.), sensor data (e.g. temperature, acceleration, position (orientation and/or location via e.g. GPS/cell identification/triangulation), light intensity), application usage, microphone usage, loudspeaker/audio output such as music reproduction, camera usage, any user input or action in general, calendar entries (additions/deletions and/or actual realization/activation thereof), and in principle the observations can range from simple temperature-type logging to all-day audio and video recordings, for instance, which are automatically observed (recorded) in the device.

The mobile terminal preferably supports multi-thread observation logic, where each observation is done as a separate process, and without intervening with other processes of other applications. In such cases, problems in reading data and consequent crashes of a specific thread will have a minimal impact on other applications. Conducting observations is guided by the aforementioned intelligent triggering logic, preferably customizing observations based on the nature and/or importance (priority ranking) of the data point, contextual factors, external input, and/or existing technical restrictions.

The various embodiments of a mobile terminal disclosed herein (also referred to as a “processing device”) preferably include logic for intelligent pre-processing and/or filtering of life feed data locally. Particularly when the amount of life feed data observed from device APIs is considerable, the ability to filter out irrelevant data is advantageous. The filtering logic, data handling logic in general and thus the overall intelligence of the terminal may be advantageously functionally linked to the server-side environment in order to obtain instructions to facilitate, for example, the update of locally applied rules and algorithms, and offering benefits arising from the availability of wider datasets in the server environment (for instance, in recognizing patterns). Depending on the embodiment, the mobile terminal may thus be self-learning, adaptive, and/or incorporates input from the server-side intelligence repository. The mobile terminal may specifically include the aforementioned data input module for obtaining the external input.

Preferably, the mobile terminal is configured to push the data towards servers at appropriate time instants. For example, the intelligence engine of the terminal, which may spread between several functional entities of the terminal such as observation logic (observation intelligence engine) and data handling agent (mobile intelligence engine), may determine the optimal time to transmit processed data from devices to server(s). The intelligence may be implemented using contextual triggers (e.g. location changes), behavioral triggers (e.g. user's actions), time limits (e.g. regular transmission), emergency condition (for instance, when fire observed in the proximity of the phone), cost-efficiency (transmitting after a certain threshold of data is collected to local memory, limiting the costs of transmission) and battery-optimization (saving as much of the battery as possible). The intelligence engine is preferably capable of learning from the collected data, observed patterns, and/or input from external entities such as servers, and adapt to contextual dimensions as well.

In one embodiment, a data handling agent mainly coordinates the data flow output through the observation logic, thus maintaining the overall agent-side intelligence of the system logic, and transmits the observed data to one or more servers. The data handling agent is preferably capable of streamlining and filtering data by the data observation logic, combining data points (adding, for example, active cellular base stations indices to battery level changes), enriching data (for example, adding temperature to obtained GPS coordinates) and/or in other ways converting the stream of data into a more meaningful and richer information flow. In addition, a data handling agent may maintain an intelligence repository as part of a mobile intelligence engine in order to enable more efficient rules for conducting, organizing, processing and transmitting data. An observation intelligence engine may control what, how and when to conduct observations on the mobile agent side. The mobile intelligence engine may also receive input from the external entity such as a server module through one or more data input APIs.

For example, the status of the user's friends can be provided by a server, which is optionally configured to activate a more frequent location retrieving in the terminal, and observation logic thereof, provided that the user and his friend are approaching the same location and thereby indicating a high likelihood that they may meet at or near a particular point. The data handling agent is preferably enabled to store the observation data stream and intelligence data in a local memory for temporary storage. The data handling agent also performs data transmission, which optionally may involve authentication, encryption and/or other type of securing the data streams and connections. Data transmission for the logic of the data handling agent may be based on triggers and adaptive rules that make it flexible and adjustable to different situations and use cases. The data handling agent may interact with the user interface of the device, for example in mapping subjective information or semantic data asked directly from the users to observations.

In the embodiments of a mobile terminal, one or more data input modules may be used for receiving data from external entities such as a server side. In one embodiment, a data input is automatically started when the connection is open towards the server (i.e. when data transmission triggered towards the server takes place). It may, however, operate independently. The data input module may have a processing logic of its own to categorize and process the received data, and optimally inform the data handling agent about it. For example, simple contextual parameters like temperature might be directly stored in a temporal cache memory to be used by a data handling agent for enriching observations, but on the other hand intelligence rules (such as the fact that in the current operator's network the frequency of network tower polling should be 50% more frequent in daytime) will be incorporated in the set of rules making up the intelligence logic of the mobile agent. Such intelligence logic may be maintained by the data handling agent and optionally the observation logic for subsequent processing. The data input module is also responsible for managing and transmitting to the data handling agent a variety of intelligent messages that need to be pushed to the user interface of the wireless device, ranging from geo-social advertisements to contextual notifications from other wireless devices.

In a preferred embodiment, the server arrangement is configured to mutually link observation data points relative to users, locations, contexts, weather and/or any other information. Data aggregation may take place in each mobile terminal as described above. In another embodiment, the server arrangement utilizes gradual aggregation and temporal resolution adjustment for obtained data such that the most current data is very granular and accurate, while later data may be optimized for data storage. For example, in instances when limited location points are stored for a number of monitored days, a weighted average of geo-locations may be used for the time period instead. The server arrangement may also maintain lists in a further, supplementary or alternative, embodiment the server arrangement maintains, or has at least access to, a social contact (e.g. friends) database indicative of the existing social connections between the users of the mobile terminals.

The server side entity of the present invention is unique in the sense that it incorporates collective data for all devices being connected to the system in contrast to the end-to-end pipelines of prior art. Other advantageous functionalities of the server include bridging external data (for example, weather or traffic information) to device-based data and use of cumulative wisdom from all the possible data points and external APIs in optimizing the internal rules and processes (the intelligence), and also transforming and providing these improved rules to mobile terminals for use in local observation tasks and related local intelligence. In addition, novel functionalities of the server preferably include pull and/or push mode data distribution APIs that facilitate distribution of multi-dimensional data to external systems and mobile terminals, without specifying these use cases or doing unnecessary assumptions beforehand (the typical shortcoming in prior art solutions).

The server arrangement may reside in the intersection of the social networks, external environmental data, specific behavioral and contextual data provided by the mobile devices, and overall intelligence embodied on tangible mediums provided by, e.g., algorithms, data aggregation and mining procedures, pattern recognition, semantic structures, etc. It may be configured to enrich the data, update statistical averages, build cumulative databases, make observations across individuals (for example to identify two users' proximity), make predictions by relying on the amount data, and utilizing statistical processing to calculate likelihood estimates for different outcomes to happen. The server side intelligence may incorporate, depending on the embodiment, intelligent functionalities such as suggestions of advertisements to specific users, to be sent by these users to other users of their social networks. For example, an individual user entering a restaurant can be informed of a happy hour discount for beer in a local bar, and the system suggests to the user the related ad to be sent to one of his friends (thereby leading potentially to a meeting between the friends in the local bar), also located in the neighborhood. This advertisement, which may be received by a friend through a viral path, is an intentional message from one of his friends or business contacts, not a disturbing pop-up push-mode message by a practically unknown third party as being the case in most prior art solutions for targeted mobile advertising. Thanks to the feedback loop to the mobile agents, these kinds of smart, context-dependent social advertisements can be implemented together.

The aforementioned analytics and data processing logic may be implemented as a software module embodied on a tangible medium, which acts as a centralized location wherein all external APIs' data (e.g. names of locations, temperatures), device-based data and social network data can be conceptually brought together. An intelligence engine of the server, which may be spread among several entities (into centralized intelligence engine and API intelligence engine, for instance), coordinates the operations, maintains the set of rules, a sub-set of which will also be sent to mobile agents through the data distribution logic such as a data distribution API, and its internal interface. Centralized and API intelligence engines are preferably adaptive and self-learning, coming up with patterns or other insights regarding, for example, the topology and cellular tower locations of a particular operator's network. A data management module may be applied to maintain the enriched, modified and processed data outputted by enrichment and processing module, which streamlines all the information received, preferably adding semantic dimensions, etc. The data management module may therefore administer vast clusters of databases or database servers, in which all the data (observations, other information, intelligence rules) are stored preferably in a scalable way, the resolution of data stored being gradually narrowed temporally for historical life feed data as mentioned earlier. A data provisioning module may be provided to query the databases in an optimal way, when the need arises, and feed information further to the data distribution API for output.

Various embodiments disclosed herein may facilitate generating a life feed, reflecting real life, relevant data being collected from the true point of presence and end-user inspiration—the mobile terminal. Thus a mobile terminal may be configured to conduct various observations (monitoring) and handle pre-processing and forwarding thereof. The obtained life feed is preferably multi-dimensional, data points thereof following each other (time-series temporal nature), context-linked and context-aware (e.g. time, status and location), ubiquitous (everywhere, all the time), seamless and automatically created from the user's standpoint. The Various post-processing methods, analysis intelligence, self-learning aspect (e.g. self-learning triggers) and/or adaptive logic may be integrated as a result.

Automatic observation logic may be arranged in the mobile terminal to run on the background as intelligently triggered and mostly passively with minimum battery consumption and capacity usage, but still with comprehensive data acquisition capability relative to the relevant data points regarding the data associated with a user's life. The observation logic is advantageously completely context-sensitive, predictive and capable of learning from historical data. The collected data points in the mobile phone may be then converted into a life feed, which refers herein to a continuous stream of data points reflecting the timeline of associated people's life.

Further, the disclosure herein presents a novel way of aggregating, combining, enriching and/or analyzing datasets in a centralized environment, bringing an advantageous collective view on the life feed data, and facilitating further coordinated use of the data. Accordingly, a centralized server-side aspect of the present disclosure is enabled to intelligently process the data (for example, to perform data filtering or clustering), enrich it (for example, to add location names to geo-coordinates), analyze it, e.g. via contextual pattern recognition, build collective real-time intelligence, e.g. via understanding when any two people are actually approaching the same location, and/or to provide the obtained information to external systems with an application programming interface that may be queried on regular intervals and/or dynamically based on separate triggers. In addition, the centralized server-side logic facilitates creating new applications, such as socio-contextual advertising, pushing targeted advertisements to people via their friends' devices, and utilizing intelligent pop-ups in devices as a method of frequent interaction with users. In brief, automated and optimized life observation logic with server-side data processing and integrated application programming interface is provided for data distribution. A specific data distribution API may enable versatile exploitation of the observation data by having access to raw-level data items and being configured to streamline raw-level data points to more focused information data points. The distribution layer supports not only static data (such as personal profiles), or dynamic status data (such as current location), but also multi-dimensional time-variant data, which are herein referred to as life feeds.

A further advantageous feature is that the system does not take a stand on the use of the obtained data. The data distribution API of the server arrangement preferably defines the optimal, comprehensive structures for the whole data intelligence (the highest level of sophistication in the data repository, the information points derived from raw-level data points through several procedures), that can be rapidly accessed when looking for specific data points. The API may be self-learning and adaptive, for example sorting the most highly requested data points to the top, and predicting the data consumption and production unbalances, being able to inform about such important properties of data such as accuracy, validity, and/or consistency. For example, certain location points might have lower resolution and others, and certain status information points might be time-wise non-current. On top of the whole architecture, the data distribution API thus lets a set of external (and internal) modules access the data in a ubiquitous and universal way. Additionally, the users can set their privacy levels and data coordination policies centrally in the server arrangement. Data distribution procedures preferably operate under the rules, restrictions and options set by the user, verifying for each query to which platform the data is flowing, and what the nature, privacy settings and type of the data point is.

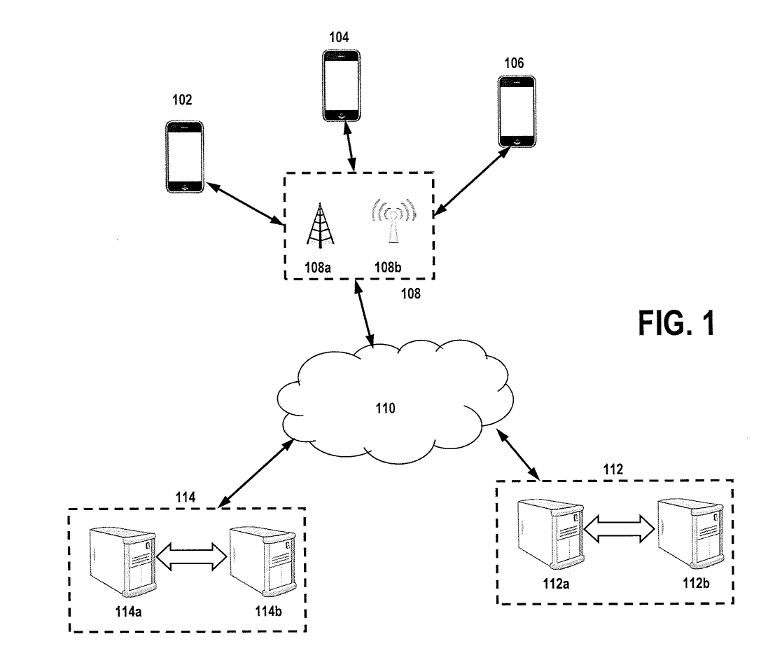

Turning to FIG. 1, an exemplary system architecture is illustrated. The exemplary system is divided into two parts, namely a mobile agent part executed in one or more mobile terminals 102, 104, 106 of respective users and a server arrangement part 112 comprising one or more server devices (112a, 112b) functionally arranged so as to establish a server entity. Devices 102-106 are configured to monitor device and data use by their respective users in accordance with the principles set forth herein. Server 112 is typically connected to a communications network 110 whereto also the mobile terminals 102, 104, 106 are provided with access, e.g. via one or more access networks 108a, 108b, which may be cellular or wireless local area networks, for instance. External entities 114 such as services/servers (114a, 114b) may be connected to the server arrangement 112 via the network 110 for obtaining observation data and further data derived therefrom and/or for providing supplementary data such as weather information.

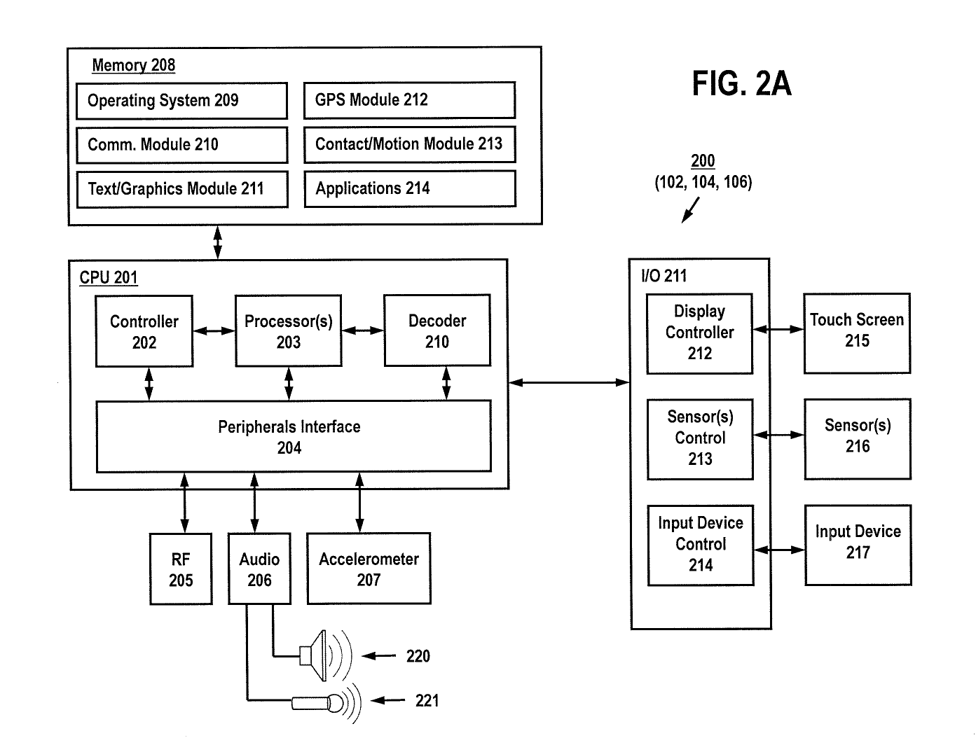

FIG. 2A is an exemplary embodiment of a portable computing device 200 which may function as a mobile terminal (see references 102, 104 and 106 of FIG. 1), and may be a smart phone, tablet computer, or the like. Device 200 may include a central processing unit (CPU) 201 (which may include one or more computer readable storage mediums), a memory controller 202, one or more processors 203, a peripherals interface 204, RF circuitry 205, audio circuitry 206, a speaker 220, a microphone 220, and an input/output (I/O) subsystem 211 having display controller 212, control circuitry for one or more sensors 213 and input device control 214. These components may communicate over one or more communication buses or signal lines in device 200. It should be appreciated that device 200 is only one example of a portable multifunction device 200, and that device 200 may have more or fewer components than shown, may combine two or more components, or a may have a different configuration or arrangement of the components. The various components shown in FIG. 2A may be implemented in hardware or a combination of hardware and software, including one or more signal processing and/or application specific integrated circuits.

In one embodiment, decoder 210 serves to decode ancillary data embedded in audio signals in order to detect exposure to media. Examples of techniques for encoding and decoding such ancillary data are disclosed in U.S. Pat. No. 6,871,180, titled “Decoding of Information in Audio Signals,” issued Mar. 22, 2005, and is incorporated by reference in its entirety herein. Other suitable techniques for encoding data in audio data are disclosed in U.S. Pat. Nos. 7,640,141 to Ronald S. Kolessar and 5,764,763 to James M. Jensen, et al., which are incorporated by reference in their entirety herein. Other appropriate encoding techniques are disclosed in U.S. Pat. No. 5,579,124 to Aijala, et al., U.S. Pat. Nos. 5,574,962, 5,581,800 and 5,787,334 to Fardeau, et al., and U.S. Pat. No. 5,450,490 to Jensen, et al., each of which is assigned to the assignee of the present application and all of which are incorporated herein by reference in their entirety.

An audio signal which may be encoded with a plurality of code symbols is received at microphone 221, or via a direct link through audio circuitry 206. The received audio signal may be from streaming media, broadcast, otherwise communicated signal, or a signal reproduced from storage in a device. It may be a direct coupled or an acoustically coupled signal. From the following description in connection with the accompanying drawings, it will be appreciated that decoder 210 is capable of detecting codes in addition to those arranged in the formats disclosed hereinabove.

Alternately or in addition, processor(s) 203 can processes the frequency-domain audio data to extract a signature therefrom, i.e., data expressing information inherent to an audio signal, for use in identifying the audio signal or obtaining other information concerning the audio signal (such as a source or distribution path thereof). Suitable techniques for extracting signatures include those disclosed in U.S. Pat. No. 5,612,729 to Ellis, et al. and in U.S. Pat. No. 4,739,398 to Thomas, et al., both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO02/11123 to Wang, et al. and PCT publication WO91/11062 to Young, et al., all of which are incorporated herein by reference in their entireties. As discussed above, the code detection and/or signature extraction serve to identify and determine media exposure for the user of device 200.

Memory 208 may include high-speed random access memory (RAM) and may also include non-volatile memory, such as one or more magnetic disk storage devices, flash memory devices, or other non-volatile solid-state memory devices. Access to memory 208 by other components of the device 200, such as processor 203, decoder 210 and peripherals interface 204, may be controlled by the memory controller 202. Peripherals interface 204 couples the input and output peripherals of the device to the processor 203 and memory 208. The one or more processors 203 run or execute various software programs and/or sets of instructions stored in memory 208 to perform various functions for the device 200 and to process data. In some embodiments, the peripherals interface 204, processor(s) 203, decoder 210 and memory controller 202 may be implemented on a single chip, such as a chip 201. In some other embodiments, they may be implemented on separate chips.

The RF (radio frequency) circuitry 205 receives and sends RF signals, also called electromagnetic signals. The RF circuitry 205 converts electrical signals to/from electromagnetic signals and communicates with communications networks and other communications devices via the electromagnetic signals. The RF circuitry 205 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 205 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 206, speaker 220, and microphone 221 provide an audio interface between a user and the device 200. Audio circuitry 206 may receive audio data from the peripherals interface 204, converts the audio data to an electrical signal, and transmits the electrical signal to speaker 220. The speaker 220 converts the electrical signal to human-audible sound waves. Audio circuitry 106 also receives electrical signals converted by the microphone 221 from sound waves, which may include encoded audio, described above. The audio circuitry 206 converts the electrical signal to audio data and transmits the audio data to the peripherals interface 204 for processing. Audio data may be retrieved from and/or transmitted to memory 208 and/or the RF circuitry 205 by peripherals interface 204. In some embodiments, audio circuitry 206 also includes a headset jack for providing an interface between the audio circuitry 206 and removable audio input/output peripherals, such as output-only headphones or a headset with both output (e.g., a headphone for one or both ears) and input (e.g., a microphone).

I/O subsystem 211 couples input/output peripherals on the device 200, such as touch screen 215 and other input/control devices 217, to the peripherals interface 204. The I/O subsystem 211 may include a display controller 112 and one or more input controllers 214 for other input or control devices. The one or more input controllers 214 receive/send electrical signals from/to other input or control devices 217. The other input/control devices 217 may include physical buttons (e.g., push buttons, rocker buttons, etc.), dials, slider switches, joysticks, click wheels, and so forth. In some alternate embodiments, input controller(s) 214 may be coupled to any (or none) of the following: a keyboard, infrared port, USB port, and a pointer device such as a mouse, an up/down button for volume control of the speaker 220 and/or the microphone 221. Touch screen 215 may also be used to implement virtual or soft buttons and one or more soft keyboards.

Touch screen 215 provides an input interface and an output interface between the device and a user. The display controller 212 receives and/or sends electrical signals from/to the touch screen 215. Touch screen 215 displays visual output to the user. The visual output may include graphics, text, icons, video, and any combination thereof (collectively termed “graphics”). In some embodiments, some or all of the visual output may correspond to user-interface objects. Touch screen 215 has a touch-sensitive surface, sensor or set of sensors that accepts input from the user based on haptic and/or tactile contact. Touch screen 215 and display controller 212 (along with any associated modules and/or sets of instructions in memory 108) detect contact (and any movement or breaking of the contact) on the touch screen 215 and converts the detected contact into interaction with user-interface objects (e.g., one or more soft keys, icons, web pages or images) that are displayed on the touch screen. In an exemplary embodiment, a point of contact between a touch screen 215 and the user corresponds to a finger of the user. Touch screen 215 may use LCD (liquid crystal display) technology, or LPD (light emitting polymer display) technology, although other display technologies may be used in other embodiments. Touch screen 215 and display controller 212 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 212.

Device 200 may also include one or more sensors 216 such as optical sensors that comprise charge-coupled device (CCD) or complementary metal-oxide semiconductor (CMOS) phototransistors. The optical sensor may capture still images or video, where the sensor is operated in conjunction with touch screen display 215. Device 200 may also include one or more accelerometers 207, which may be operatively coupled to peripherals interface 204. Alternately, the accelerometer 207 may be coupled to an input controller 214 in the I/O subsystem 211. The accelerometer is preferably configured to output accelerometer data in the x, y, and z axes.

In some embodiments, the software components stored in memory 208 may include an operating system 209, a communication module 210, a contact/motion module 213, a text/graphics module 211, a Global Positioning System (GPS) module 212, and applications 214. Operating system 209 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 210 facilitates communication with other devices over one or more external ports and also includes various software components for handling data received by the RF circuitry 205. An external port (e.g., Universal Serial Bus (USB), Firewire, etc.) may be provided and adapted for coupling directly to other devices or indirectly over a network (e.g., the Internet, wireless LAN, etc.

Contact/motion module 213 may detect contact with the touch screen 215 (in conjunction with the display controller 212) and other touch sensitive devices (e.g., a touchpad or physical click wheel). The contact/motion module 213 includes various software components for performing various operations related to detection of contact, such as determining if contact has occurred, determining if there is movement of the contact and tracking the movement across the touch screen 215, and determining if the contact has been broken (i.e., if the contact has ceased). Text/graphics module 211 includes various known software components for rendering and displaying graphics on the touch screen 215, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 212 determines the location of the device and provides this information for use in various applications. Applications 214 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication.

Server arrangement 260 of FIG. 2B may comprise one or more computer devices 261 comprising a communications interface 254 such as a LAN (Local Area Network) adapter, e.g. Ethernet adapter, a processing entity such as at least one processor 250 for processing data, a memory 252 for storing data, server side software architecture 258 and UI 256.

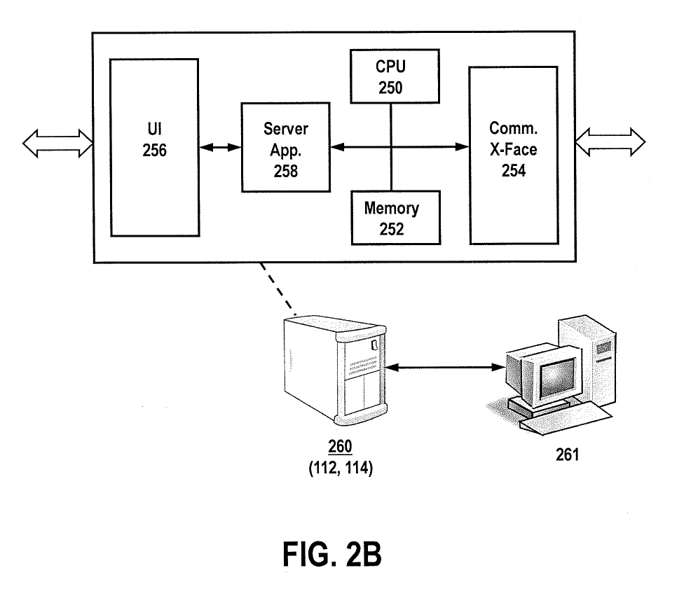

FIG. 3 represents a flow diagram of one embodiment of the system incorporating both a mobile agent and a server arrangement. One function of the agent is to observe events, actions and/or properties in the wireless devices via observation logic 300, and to perform pre-processing for the observed data and manage the device-based intelligence regarding data handling via handling agent 350. In addition, the agent is enabled, by the data input module 310, to receive data from a server, where the data may include such items as metadata, contextual data, and/or updates regarding data handling rules and observation requirements. Data input module 310 may also be used for inputting new observation code and modules, which can be incorporated in the agent software logic over-the-air. The responsibility of the data handling agent 350 is generally to coordinate the operations of the observers, maintain and control the overall intelligence, coordinate data storing and transmission, and preferably update the intelligence (via learning and adaptation) on the agent side. The data handling agent may also be implemented as a server process in the agent, serving multiple clients such as different observers.

On the server side (112), the data that is transmitted is processed (filtered, enriched, combined, analyzed, and/or normalized, and so on), in the server-side analytics and data processing module 360. Module 360 preferably serves in a central role, being able to use not only the information from devices, but also externally available data, such as temperatures and location names. In addition, the server is able to apply collective intelligence on the data, for instance, to automatically and seamlessly to identify relationships between data points. The server may observe that two friends are located next to each other provided that each of them sends a location update from close to each other at approximately same time, for instance. As one particularly advantageous feature, the server deploys intelligent algorithms making sense out of the multi-dimensional, geographical, social, contextual and/or behavioral datasets that it handles in its relational (and in many cases semantic) databases.

The whole system has been designed efficiently so that the server is more than just a cache, and implements a centralized intelligence engine coordinating the operations of the aggregate system, the clients of which being able to utilize its collective intelligence through two-way communication protocols and their own adaptive and learning logic. A data distribution API 370 is also located on the server side. It advantageously serves as a simultaneous starting and ending point of the data flow, i.e. providing access to internal and external interfaces for query data. This API is flexible as it not only provides simple one-dimensional status information, but can provide a stream of activities as well. For example, one potential query might be to provide a list of movement activities during the last seven day in the New York Manhattan area, during which the temperature has been higher than 30 degrees Celsius, and at least one of the user's friends has been in the radius of five kilometers. In contrast to conventional arrangements, the system disclosed herein does not necessarily require fixed data pipe-lines or interfaces, but instead builds the logic on top of a flexible multi-use data distribution API.

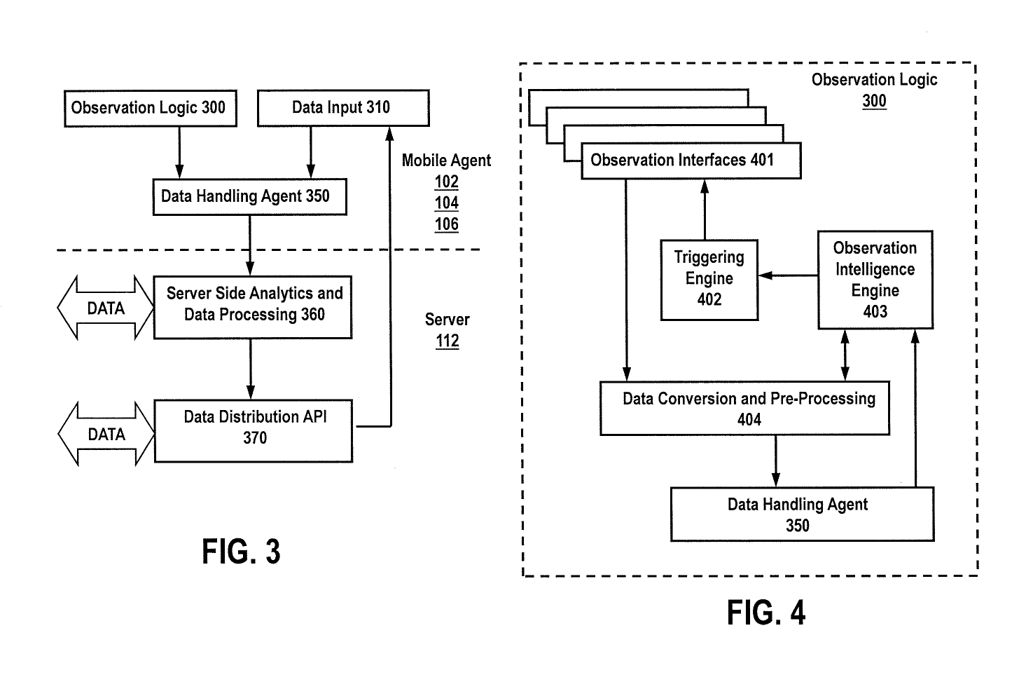

In FIG. 4, an embodiment of data observation logic 300 is illustrated. A number of observation interfaces 401 handle the monitored observations, determine the context, activities and device information, and stream the data to the data conversion and pre-processing layer 404, which is then configured to perform desired raw-level data conversions and processing activities on the data. For example, it may convert pure observations into more informative and easier-to-handle standardized XML format. The triggering engine 402 coordinates observations by optimally triggering the sensors. The observation intelligence engine 403 receives external data (e.g. from the server-side, directed by the mobile intelligence engine 553), maintaining the rules of data observations and pre-processing, guiding the respective modules.

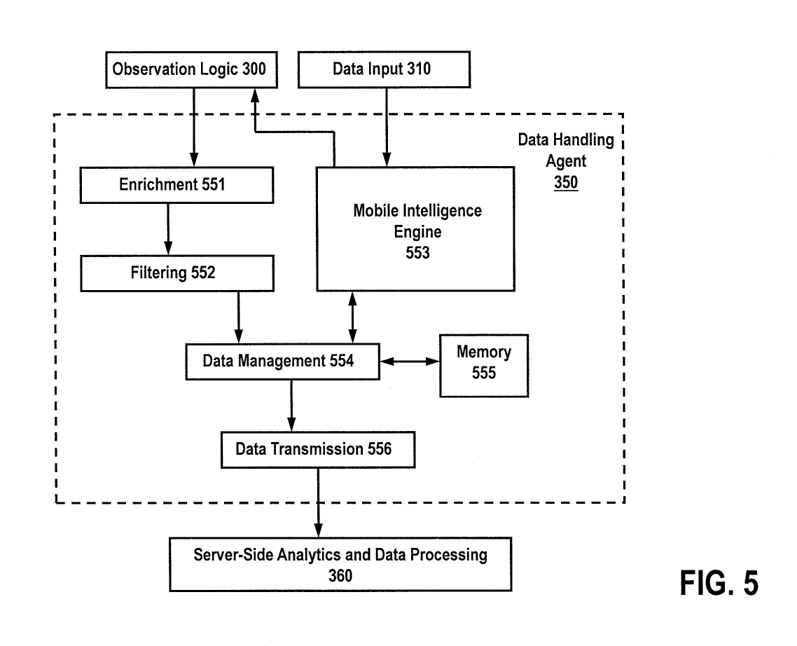

With reference to FIG. 5, an embodiment of the data handling agent 350 is described. Data handling agent 350 may be configured to receive observation data from observation logic 300 through the enrichment module 351. XML and similar data coming from the mobile device may be enriched with other data points, such as the timestamp of a previous data point or identification codes and/or signal strengths of the currently active or all visible cell towers. Filtering logic 552 is next applied to data to remove redundant or useless data, and also sort and otherwise validate the data stream. Data management module 554 manages the data, including but not limited to data analysis. This module also coordinates locally storing the data in memory 555 and feeding it to data transmission module 556, and thus further towards the server 360. Data management module 554 also extracts information, processes the information to “learn” data patterns or other characteristics, and preferably feeds it substantially in real-time back to mobile intelligence engine 553, thus coordinating the agent side of the system. For example, it can be observed that active cellular tower identification codes are changing rapidly, meaning that the topology of the network at that point is very dense (tower-wise) or that the wireless device is moving. Mobile intelligence engine 553 can incorporate that information, and consequently coordinate the observation intelligence engine 403 of the observation engine to more frequently observe locations and movements. Mobile intelligence engine 553 may also coordinate optimal transmission of data through the data management layer. Data input module 310 receives data from the server-side and feeds it to the mobile intelligence engine 553.

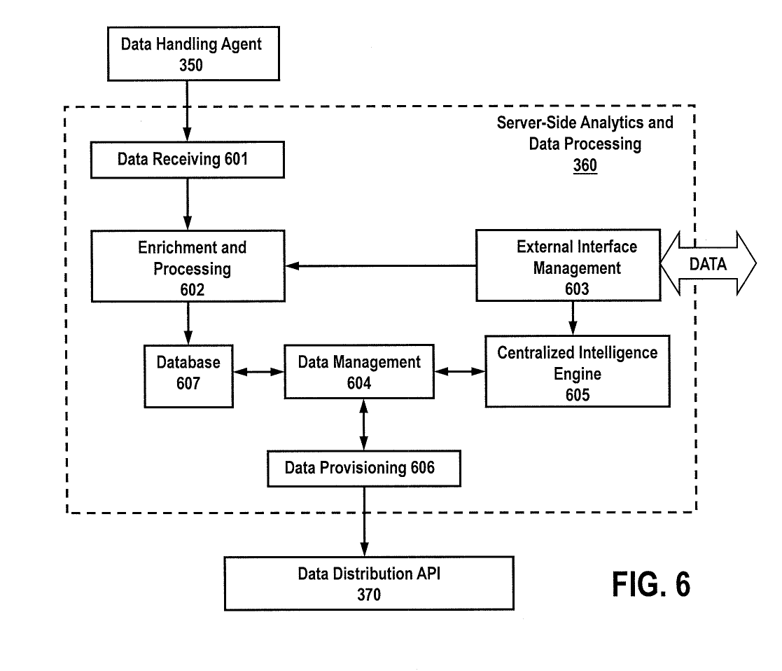

In FIG. 6 an exemplary embodiment of the server-side analytics and data processing module 360 is illustrated. Data is received from the data handling agent 350 of the mobile terminal by the data receiving module 601. This module is preferably scalable and enabled to receive data points from multiple wireless devices at the same time. On the server-side is the data enrichment and processing layer 602, in which relevant, possibly contextual, processes are applied on the incoming data. This module may be configured to apply the external interface management module 603 in order to obtain information from outside, such as weather information supplied by weather data provider. The processed data is fed to the data management module 604 that stores the data into one or more databases 607 and maintains the database(s). This module is guided by the centralized intelligence engine 605 that can also incorporate information from external interfaces. Database 607 is intelligent and capable of holding more accurate and granular data for the most current data, and optimizing the storage of historical data by averaging statistics and decreasing the resolution, for example. Data provisioning layer 606 is enabled to feed data stored in the database(s) 604 to the data distribution API 370.

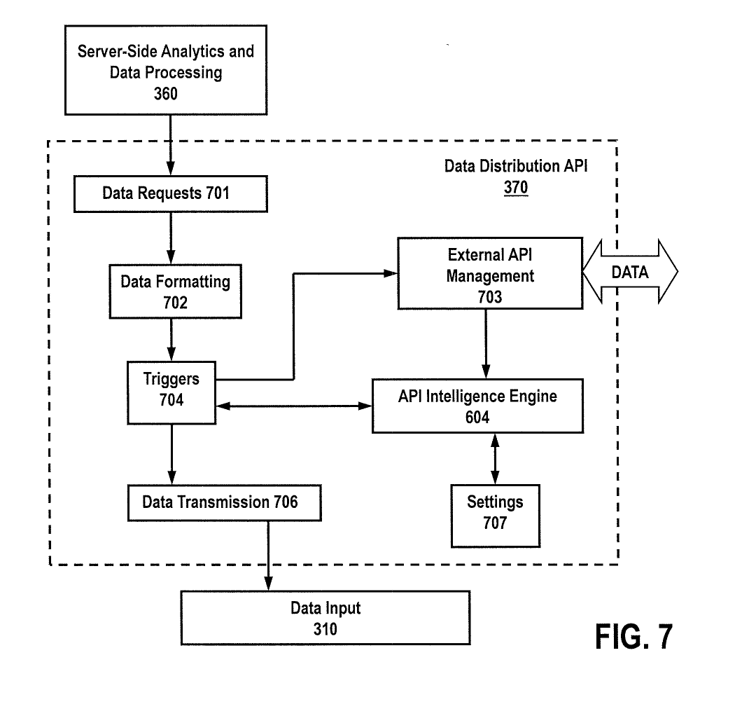

In FIG. 7, an exemplary embodiment of the data distribution API 370 is depicted. Data request module 701 queries the databases and further directs the data to data formatting module 702 that is responsible for converting the data and changing it to the appropriate format. Triggering logic 704 is responsible for guiding the data transmission module 706 that eventually sends the data to the data input module 310 of the mobile terminals, and/or to external interfaces through the external API management module 703. This module is naturally of importance, as in many use cases data shall be provided to other services of the communication network. Indeed, the overall system described in this document is primarily designed for data collection, management, analysis and distribution functionalities. API intelligence engine 705 coordinates the operations of data distribution API 370, verifying, for example, user settings (privacy, data distribution guidelines) on the basis of a separate settings module 707 preferably when transmitting data. Accordingly, the configuration facilitates proper and efficient coordination of data possibly flowing from multiple devices (sources) to multiple use cases (targets; for example web services and physical devices) by the described centralized platform for data management.

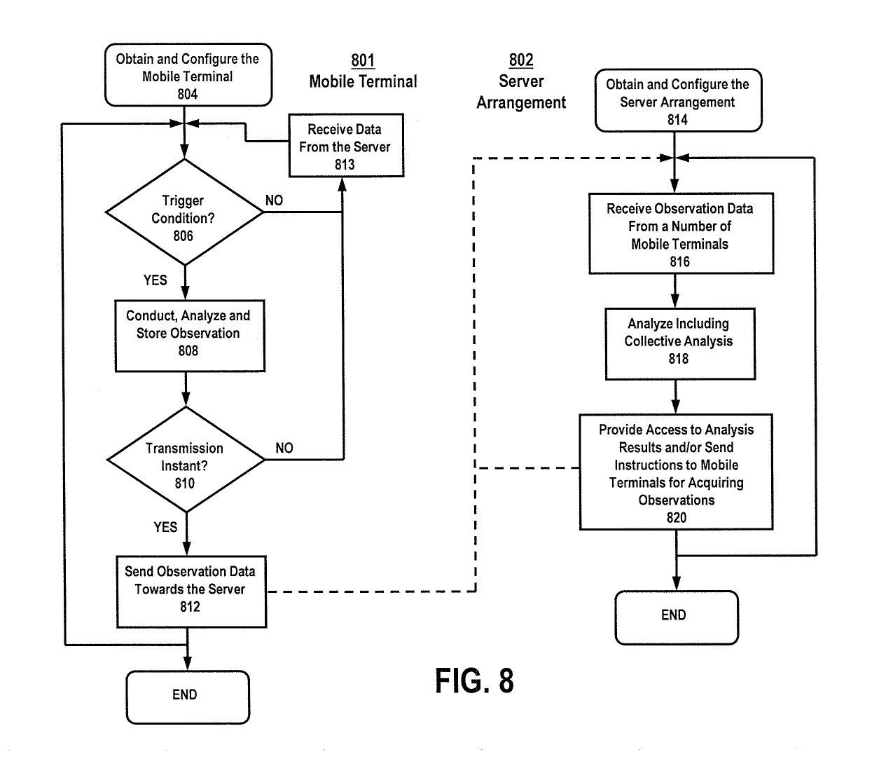

FIG. 8 is a combined flow diagram of two exemplary embodiments directed to techniques performed by a mobile terminal and a server arrangement. On the left side 801 operations performed in the mobile terminal are illustrated whereas the right side process 802 depicts exemplary tasks of the server arrangement. Both entities may communicate with each other as highlighted by the broken arrows. Loop-back arrows depict the real-time nature of the configuration, i.e. the method steps may be executed repeatedly in a sequential or selective manner. At 804 a mobile terminal, such as a smartphone, capable of executing agent software disclosed herein is obtained and configured by acquiring the software (“mobile agent”) and adjusting the settings thereof, for example. Existing active and passive triggers are served upon noticing a fulfillment of a triggering condition 806 by conducting 808 the associated observations, and further analyzing and storing the associated data. Upon a suitable time instant 810 the aggregated observation data are transmitted towards the server for further analysis, storage, feedback (for example, observation control) and/or distribution purposes. Step 813 illustrates the receipt of control data, e.g. control instructions, from the server for conducting the observations and/or related tasks such as data distribution.

At 814 the server arrangement is obtained and configured by acquiring the software and adjusting the settings thereof. Observation data is received 816 from a number of mobile terminals and analyzed 818 comprising both context and behavioral modeling, wherein the observation data by a plurality of mobile terminals is preferably collectively applied together with optional supplementary data. At 820, observations in the mobile terminals are conducted and may be adaptively guided by transmitting associated control data established on the basis of the analysis, e.g. triggering rules for active observations and/or event definitions for passive observations, towards one or mobile terminals. Also other external entities, such as servers, may be provided with access to analysis results. It is understood by those skilled in the art that the illustrated flow diagrams are merely exemplary and the nature and number of method steps, and the order thereof, may be dynamically adjusted based on the needs of the designer. More complex features of the embodiments are also contemplated within the context of the present disclosure.

The triggering logic mentioned above may actively or passively trigger observations. Passive triggers are tied to a certain event or action, which can be sensed and consequently the actual observation can be conducted and log entry written. Typical examples include observations associated with changing cellular towers, changing battery levels, and/or communication actions. In contrast to the prior art, the present disclosure provides triggering logic based on the number and/or frequency of sensor outputs. For instance, the actual observation(s) can be made after a certain number of cellular tower changes have been observed within a defined time limit. Below an exemplary pseudo-code representation is provided of the mentioned passive trigger that is based on the frequency of observed changes in a certain sensor “A”:

Examplary Code 1: Trigger based on changes/actions/events
during a time cycle

```
RESET:
SET CHANGES = 0
SET PREVIOUS = 0
SET START = TIME
LOOP
      OBSERVE A
      IF A ≠ PREVIOUS
      CHANGES = CHANGES + 1
      IF (TIME-START) < THRESHOLD AND CHANGES > LIMIT
      TRIGGER_GO = 1
UNTIL (TIME-START) > THRESHOLD OR TRIGGER_GO = 1 IF
TRIGGER_GO = 1
THEN TRIGGER
GO TO RESET
```

Active triggers may be defined not as tied to the sensors, but based on fixed time limits and/or other triggering rules obtained from the server side or being user-defined. Another functionality of different embodiments is the observation logic, which is preferably passive and in a number of ways scalable, as each observation may be run in a separate thread, appearing as a client to the data handling agent 350. The overall software implementing the mobile agent is advantageously not a separate application that has to be specifically launched. Instead, it preferably loads itself to the memory when the device powers up and runs invisibly/transparently on the background ever since. It independently communicates with the server and starts new observers, collecting the data that they feed regarding behavioral and contextual observations. There are various kinds of observations that can be done, for example, including at least one element including, but not limited to:
1. Currently active cellular tower and/or all visible cell towers and their corresponding signal strengths (reflecting the current geographical location);
2. Voice calls and messages (e.g. outbound/inbound SMS, MMS, regular voice calls, emails etc);
3. Calendar appointments (meetings, notes, anniversaries etc.);
4. Application usage (web browser usage, calendar usage, camera usage);
5. Data sessions (opening the PDP (Packet Data Protocol) context, transferring data over Internet protocols);
6. Media consumption (music and video playback, streaming content from the Internet)
7. Battery status (status of the battery, i.e. how many bars there are left); and/or
8. Temperature (measured temperature inside/outside of the phone)

Another functionality of the embodiments is the device-based pre-processing. Outlier filtering procedures, data conversions such as conversions from raw hexadecimal observations to the standardized XML Unicode feed, factor analysis, weighted averaging and/or other such methods may be applied in certain situations in the mobile agent. More specifically, locally available information may be matched to data points, a good example being the attachment of time stamps and/or currently active cellular tower identification codes to the data points. By doing this in advance on the mobile side, the load and complexity of the server-side is minimized. On the other hand, the processes performed on the agent side may be restricted as to data processing to allow the server-side to perform more complex intelligence-driven rules and higher level data analysis.

Furthermore, optimal pushing of data to servers, together with parallel data communication with the server(s), are preferred functionalities of the system. The mobile intelligence engine of the agent can decide based on various parameters the optimal times of data sending and receiving. For example, the algorithm responsible for triggering this logic may be based on at least one condition including, but not limited to:
1. Location of the device;
2. Movement of the device (e.g. movement status);
3. Time of day;
4. Day of week;
5. Behavioral input (user's actions, such as voice calls); and/or
6. Device status information (battery status, temperature, memory capacity)

In data transmission both authentication and encryption methods and/or algorithms may be used, securing thus the transmission of potentially private information.

Data mining practices on the server-side are desired processes of the overall system, the server side in general playing one key part of the whole architecture. The server side can holistically input all the data from the devices, recognizing any possible patterns and processing data, and deriving information based on statistical analysis. Procedures, such as multi-variate generalized non-linear and linear regression methods, factor analysis, cluster analysis, classification utilizing, for example, neural networks, non-parametric tests and survival analysis may be automatically used, though discretely, on the received and locally stored data.

To provide a skilled reader with few tangible data analysis examples, exemplary embodiments of algorithms directed to context modeling and user segmentation are provided herein. In context modeling, a graph or map may be generated from data points to illustrate cellular towers. Instead of data collected by individual users (as done by most prior art arrangements), a more comprehensive dataset by a plurality of users, e.g. substantially all users, is preferably used. The nodes of a graph may be configured to correspond to cellular towers and the weights of the links reflect the observed number of 2-way jumps (for example, a jump from base station A to base station B and back) in the network (instead of relying on one-way jumps, which can also reflect movements instead of access jumps when halt), thus better communicating their possible physical closeness. A cluster analysis approach may be then applied and many cellular towers grouped together to form one physical area, though based on non-geographical data points. Later on, user-inputted or pre-coded semantic information such as “home” or “office” may be added based on time distribution based semantic algorithms. Even geo-location information can be attached to the cellular towers, if appropriate observations can be made in the agent, or alternatively, server-based matching technologies can be used.

In a similar fashion, a plurality of users can be clustered to form behaviorally coherent groups. The nodes of the graph represent this time users instead of cellular towers. The weights between the nodes may be Pearson correlation coefficients (or equivalent), calculated, for example, based on activity (e.g. overall device usage in minutes of usage per day) or location-based variables (for example distance between users). In the examples here, the original data to describe edges between nodes may be multi-dimensional, in other words meaning that multiple weights between nodes can be calculated in the first place.

In view of automatic clustering, a modularity-based approach to analyze the graphs produced by the platform is described. The modularity may be defined as follows. Denote by eᵢⱼ half of the fraction of edges in the graph that connect vertices from community i to community j, given that i≠j. Half of the fraction is chosen instead of the full fraction since the normalization demands that eᵢⱼ+eⱼᵢ equals the total fraction. Denote also by eⱼᵢ the fraction of edges inside community i.

Using this notation, the sum

$${b}_{i} = {\sum }_{i = 1}^{N} {e}_{ii}$$

equals the fraction of edges that fall within the communities of all edges, while

$${a}_{i} = {\sum }_{j = 1}^{N} {e}_{ij}$$

is the fraction of ends of edges that emanate from vertices in group i. Now, if all edges were connected at random, the fraction of them inside community i would be aᵢ². This lets one define the modularity Q as

$$Q = {\sum }_{i = 1}^{N} ( {e}_{ii} - {a}_{i}^{2} )$$

If the edges are random, the modularity equals zero, whereas values Q>0 indicate a clustered structure. Usually values of about Q>0.3 or 0.4 can be considered as signs of significant clustering.

The used method of optimizing modularity my operate as follows. Let initially each vertex form a community of its own. Consider all possible aggregations of two communities into one, and compute the modularity after these joins. Choose the one with the highest modularity and aggregate the communities together. Repeat this procedure iteratively for the new set of communities until there is no pair of two clusters the joining of which would increase the modularity. The communities at this point are then the best division of the original graph into communities in terms of the algorithm.

Denoted by dᵢⱼ the measurement of node i in measurement group j. By dividing the values with the measurement group averaged ones

$${α}_{j} = \frac{{\sum }_{i = 1}^{{N}_{p}} {d}_{ij}}{{N}_{p}}$$

where Nₚ is the number of nodes, the scaled measurements βᵢⱼ can be defined as

$${β}_{ij} = \frac{{d}_{ji}}{{α}_{j}}$$

leading to the vectors

γₖ=(βₖⱼ)₍ⱼ₋₁₎^{(Nα)}

describing the patterns of individual node k. Here, N_{α} is the number of measurement groups. Using these vectors, it is possible to define the similarity coefficients for nodes k and l as explained below.

Using these similarity coefficients, a fully connected weighted graph may be built with the edge between nodes k and l having the weight wₖₗ determined, for example, by using Pearson correlation coefficient. The algorithm takes the weights of the edges into account. This may be done simply by redefining the factors eᵢⱼ to

$${e}_{ij} = \frac{{w}_{ij}}{2 {\sum }_{x} {\sum }_{y > x} {w}_{xy}}$$

where the summation is over all pairs of vertices. Newman's algorithm may be applied to produce a division of the nodes into clusters.

In addition to node clustering in the variety of relevant applications, various data mining procedures may be applied on the fly. For example, by using weighted averaging, the current movement activity of users can be updated on the servers. The outputs of all data mining practices can be substantially immediately taken into account in mobile agent operations. For example, by observing a link between two users, based on the conducted location based clustering algorithm (optionally incorporating predictive logic regarding the next hour's locations), more accurate observations can be immediately made in the respective user's wireless devices. For example, the devices can observe and servers analyze similarities in music consumption, this being a potential factor contributing to the likelihood of two users being interested in, for example, dating each other.

The data stored in the databases may be in a raw-level format (Unicode format), and various relations may be utilized in optimally storing the data. For example, a typical way to define an approximate geolocation is to identify cellular tower (base station) identification codes. Instead of storing all of the codes (MCC (mobile country code), MNC (mobile network code), LAC (location area code), CID (“cell-ID” in a GSM network, for example), the system may create a simple index for each tower, and this index is then used in mapping data points to cellular towers. In addition to heavy use of relations in linking data points to users, locations, context, weather and any other things, the database preferably utilizes time-based gradual aggregation of data as mentioned hereinbefore so that for the older data not as accurate, precise and granular data point storage is utilized as for the more recent data. For example, for the life feed items of a particular time period (e.g., week), a more accurate location for each of them might be stored. In contrast, the life feed data from e.g. a year ago can be equipped with only one day-level weighted average of the geo-location for each country.

In the data distribution API, virtualized and scalable clusters of databases may be used, optionally with a semantic database model enabling various kinds of queries, from direct to more complex, semantically formulated ones. The data distribution API may advantageously facilitate both pull and push model of data distribution. In addition, it centrally manages each user's data based on universal privacy settings, data sharing conditions, and/or other centralized data management settings the user has defined. The data distribution API secures that the data flows efficiently to proper interfaces in a correct format. The data distribution API queries the data from the server-side data management module 604, physically for example from the database clusters 607 by utilizing the data provisioning module 606 as the main interface. The data may be outputted in various formats. Widely used standards such as XML and GeoRSS may be applied for pre-defined data streams. In addition, customized interfaces can be easily built between the data distribution API and widely used external services offered in the communication network, using the request formats of the API. Some exemplary request types include at least one element including, but not limited to:

1. Status information retrieval (e.g. location, context, profile status);

2. Users currently in a certain location;

3. Users having used the web browser at least once during a certain time period;

4. List of countries a specific user has ever visited;

5. The most typical location for a specific user;

6. Likelihood estimates (predictions) for a particular user's location in 1 hour;

7. The image content feed from a particular location during a certain time period; and

8. Updated behavioral profile of a user based on application usage patterns

Parameters that may be included in the queries comprise at least one element selected from the group including, but not limited to:

1. User identification

2. Time

3. Location (old, current, future)

4. Status information (“moving”, “busy”)

5. Context (semantic, for example home, school, office, bus)

6. Behavioral patterns (application usage)

The data distribution API may also facilitate external widgets or applications to perform queries in the database. For example, a platform-specific application may be built for social networking services, with its own user interface and functionalities that plots the data provided by this system through the data distribution API. The data distribution API does not take a standpoint on how the data is to be used, but specifies a multi-use interface to easily make queries to the intelligent and optimized database of life feed data. The same data distribution API can be combined with the external interface management module 603 to input data to the system's cumulative databases, instead of just distributing data from the database.

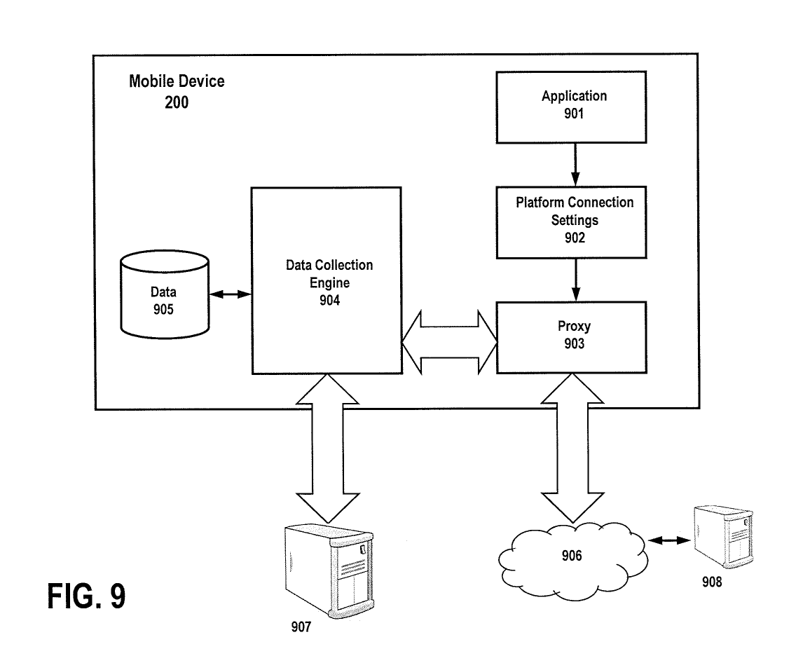

Turning to FIG. 9, another embodiment is disclosed, where mobile device 200 is equipped with an internal proxy for channeling data streams going to/from the device. Such a configuration is particularly advantageous for controlling and processing network activity on device 200. In addition to the embodiment shown in FIG. 9, device 200 may incorporate any and all features described above in connection with mobile device configurations. In the illustrated embodiment, mobile device 200 comprises one or more applications 901, which in this example may be a browser or other network-capable application that communicates using platform connection settings 902 that establish a suitable connection format. For example, if application 901 is establishing a connection via a GSM carrier, settings 902 may configure an Access Point Name (APN) network identifier for the mobile device. A carrier may then utilize this identifier to determine what type of network connection should be created (e.g., what IP addresses should be assigned to the wireless device, what security methods should be used, and how or if, it should be connected to some private customer network). Additionally, Wi-Fi configurations or other types of configurations may be processed through platform connection settings 902. Outgoing and incoming communications are then routed through proxy 903. During operation, the APN may identify an IP Packet Data Network (PDN) that the device wants to communicate with, and may also be used to define the type of service, (e.g. connection to wireless application protocol (WAP) server, multimedia messaging service (MMS)), that is provided by the PDN.

Proxy 903 is preferably configured as a dynamic mobile device client that is capable of handling specific communications based on configurable rules. As one example, all HTTP communication may be routed through proxy 903, where proxy 903 may simply pass the communication to network 906, or may alternately modify outgoing requests to route them to a network proxy (908) communicatively coupled to network 906. Importantly, proxy 903 is configured to perform data collection for communications to/from application 901, which is forwarded to data collection engine 904, which in turn stores the data in 905 and may forward data to remote server 907.

As an example, application 901 may request a specific website (e.g., http://www.cnn.com/) that returns a page containing multiple objects, such as pictures, text, advertisements and the like. Data relating to the request and the received objects is collected by proxy 903. The collected data objects may be generated from network requests and responses including headers, parameters and a message body. Thus, for example, data relating to headers, parameters and message body of requests are collected, and data relating to the headers and body of the response is collected and sent to data collection engine 904 (and stored in 905). The collection and storage may occur in real-time, or may be arranged to occur on a predetermined schedule. When setting up the arrangement of FIG. 9, application 901 or platform connection settings 902 are preferably altered to route data through proxy 903 and/or data collection engine 904. The routing may be configured automatically via software, or manually re-programmed by a user.

In further embodiments, it may be advantageous for a system (e.g., FIG. 1 et. al.) to be able to provide modifiable (dynamic) logic for obtaining observational data. To improve the quality of metered data, it is often desirable to collect larger amounts of data for analysis. Unfortunately, this often comes at a technological cost in terms of data transfer and processing costs. Furthermore, the metered device may be impacted by excessive battery drain and performance cost. Accordingly, it would be advantageous to enable a data observation or device metering system to selectively modify the time and/or manner in which data is collected. Referring to the embodiment in FIG. 1, either of server arrangements 112, 114 may be enabled to store and transmit modified observational instructions/parameters to any of devices 102-106. Under one embodiment, the modified observational instructions may be transmitted to the devices at predetermined times, without any user interaction. In another embodiment, the instructions may be transmitted upon request from any of devices 102-106. In still another embodiment, the modified observational instructions may be transmitted upon the activation of a trigger. In another embodiment, the modified observational instructions/parameters may be incorporated into software or applets, that may contain additional executable instructions, which are transmitted from the server arrangements.

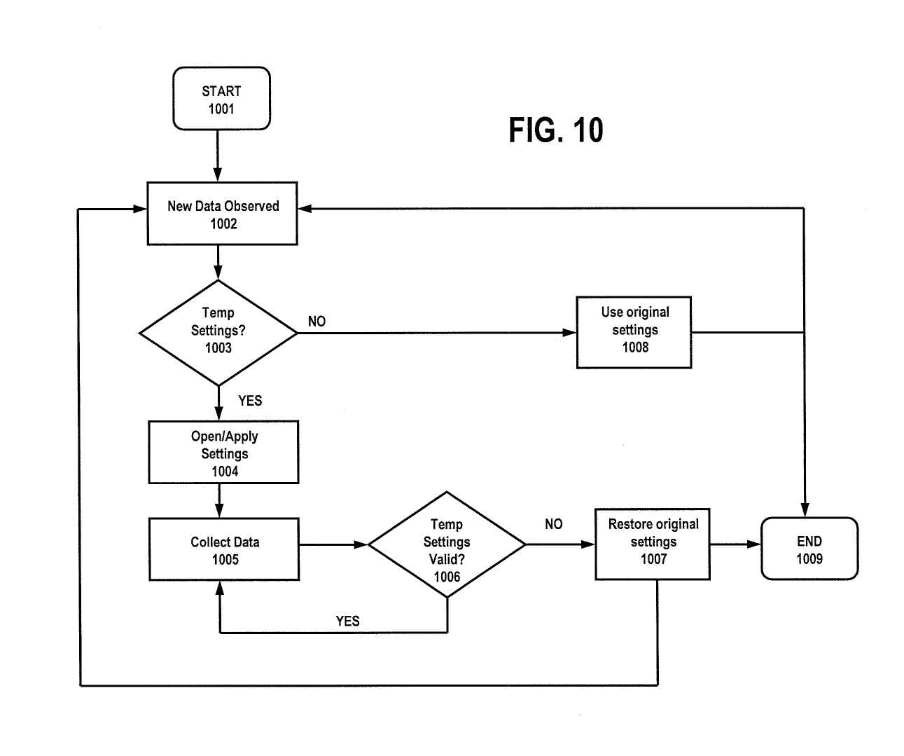

Under a preferred embodiment, once the instructions/parameters transmitted and downloaded in any of devices 102-106, it is configured to automatically install and incorporate itself on the device. The instructions/parameters allow observational parameters to be modified in the mobile agent observation logic (300) and/or data handling agent (350) over a predetermined period of time and/or the occurrence (trigger) of an event or state. Turning to FIG. 10, an exemplary embodiment is shown in which a current configuration controls device observations. At this time, the observation logic and/or data handling agent observes events, actions and/or properties in the wireless device and may perform pre-processing for the observed data and management of device-based intelligence regarding data handling. Before, during or after this time, modified temporary observation instructions may be downloaded onto the device and taken to use when pre-defined rules, triggers or time is met. At the start 1001 of the process in FIG. 10, new data is observed 1002 on the device. The new data may pertain to (i) a new “app” or software application (e.g., game) being installed or executed on the device, (ii) new or different observable data types being detected by the current device observation software, (iii) greater or lesser amounts of observable data being detected by the device observation software, (iv) a new or different device state, and/or any other events and/or occurrences.

Once the new data is observed, the device determines whether temporary settings are available and the one or more of the pre-defined thresholds are met 1003 to allow the data handling agent/logic to modify the observational parameters in the device. Under the present embodiment, the temporary settings are stored in observation software's memory. Under one embodiment, the temporary settings may be configured to collect certain data over a predetermined period of time. Under another embodiment, the temporary settings may be disabled only on the occurrence of a particular event or status. Under yet another embodiment, the temporary settings may be activated and/or deactivated using a combination of an occurrence of an event or status and a predetermined period of time. If temporary settings are not detected in 1003, the process continues to use the original (current) settings 1008 until a new data observation occurs 1002 or the process ends 1009.

If, however, the temporary settings are present and detected in 1003, the device opens and applies those settings from the observation modification software in 1004 and collects device data 1005 using the temporary setting(s). The process continues to 1006 where it is determined if the temporary setting are valid or not. As mentioned above, the validity of the settings refers to whether or not the settings have been disabled due to an expiration of time, occurrence of an event, or a combination of both. If valid, the process continues to collect data in 1005 using the temporary setting. Once the temporary settings are disabled (i.e., invalid), the original settings are restored in 1007, where data is then collected under the original settings until new data is observed in 1002 or the collection process ends in 1009.

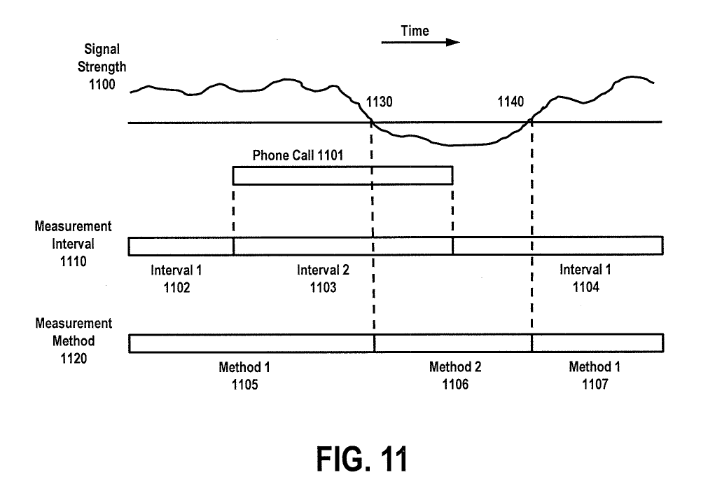

Turning to FIG. 11, an exemplary embodiment is provided for a metering service provider seeking data related to observations on a device which is equipped with observation software and temporary observation instruction management system (TEMP). In this example, the metering service provider has specified a measurement interval 1110 and measurement method 1120 for the observation software in which to collect data. The measurement interval may pertain to time intervals in which data is observed. Thus, if signal strength is being observed/measured, a first interval 1102 may be a longer time interval (e.g., 3600 s) in which signal strength is monitored, and a second interval 1003 may be a shorter tie interval (e.g., 1 s). It should be understood by those skilled in the art that additional intervals may be added according to the needs of the designer. Continuing with the example, and with regard to the measurement method 1120, a first measurement method 1105 may be specified for collecting observational data. In this case, the measurements may be related to location measurement, and the first method of location measurement may be based on network-based measurements, while a second method of location measurement may be based on GPS measurement.

The example of FIG. 11 illustrates a depiction of a portable device, whose signal strength measurement over time is shown as 1100. At a moment in time, a phone call is placed, having duration of 1101. As the beginning of the call is detected, temporary observation instructions for Measurement Interval (1110) are found from memory by TEMP, resulting a change in measurement interval from Interval 1 (1102) to Interval 2 (1103). In this embodiment, Interval 2 should be a shorter measurement interval, which in turn will result in a greater amount of observational data. When phone call 1101 ends, the TEMP reverts the measurement interval to Interval 1 (1104) in order to save resources. During phone call 1101, the device signal strength 1100 drops below a certain threshold in 1130. When the drop is detected, the TEMP executes a change in measurement method 1120, resulting in a change from Method 1 (1105) to Method 2 (1106). Assuming from the previous example that the measurement method relates to location measurement, Method 1 (1105) provides location data measurements via network while Method 2 (1106) provides location data measurement via GPS. If signal strength 1100 drops below a given threshold, the network-based location data becomes less reliable. Accordingly, the detection of the dropped signal strength triggers the TEMP to switch to GPS location measurement in 1106 in order to continue receiving location data. As signal strength 1100 is detected as rising above the threshold in 1140, TEMP reverts location observation measurement back to the network in 1107.

To summarize, the modifiable data collection instructions may be defined by a panel operator using a collection server's configuration via TEMP. As portable devices connect to a back-end, the server(s) transmit the desired temporary settings and/or triggers to one or more devices where they are subsequently stored. As an observation trigger is activated, the TEMP instructs observers to start collecting observation data based on TEMP parameters. Once a deactivation trigger is received (e.g., data, device event, expiration of time period), the TEMP reverts the changes, and the device may continue collecting observational data based on the original parameters. It should be appreciated by those skilled in the art that multiple TEMP configurations may be linked and/or nested, such that one set of temporary collection instructions may transition or change observation data collection to one or more other sets of temporary collection instructions.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for dynamically altering the collection of observation data produced on a mobile terminal, comprising the steps of:
configuring the mobile terminal to produce first observation data under at least one first parameter, wherein the first observation data comprises data relating to at least one of (i) a manner of usage and (ii) operating state of the mobile terminal;
determining, from the first observation data, if a specific data characteristic is present; and
configuring the mobile terminal to produce second observation data under at least one second parameter if the specific data characteristic is present, wherein at least one of the second parameter is different from the first parameter.

2. The method of claim 1, wherein the first parameter comprises at least one of:
an observation measurement interval for the first observational data and
an observation measurement method for the first observational data.

3. The method of claim 2, wherein the second parameter comprises at least one of:
an observation measurement interval for the second observational data and
an observation measurement method for the second observational data.

4. The method of claim 1, wherein the first observation data and second observation data are produced by an observation logic configured on the mobile terminal.

5. The method of claim 4, wherein the first observation data and second observation data comprise at least one of behavioral, technical and contextual data exhibited on the mobile terminal.

6. The method of claim 1, wherein the step of configuring the mobile terminal to produce second observation data comprises setting a disabling parameter for producing second observation data, said disabling parameter being based on at least one of a time parameter and a mobile terminal event parameter.

7. The method of claim 6, further comprising the step of configuring the mobile terminal to produce only first observation data under the at least one first parameter if the disabling parameter is met.

8. A method for dynamically altering the collection of observation data received from a mobile terminal, comprising the steps of:
providing first software instructions for the mobile terminal for producing first observation data under at least one first parameter, wherein the first observation data comprises data relating to at least one of (i) a manner of usage and (ii) operating state of the mobile terminal, and wherein the first software instructions are configured to determine if a specific data characteristic is present in the first observation data;
transmitting second software instructions for the mobile terminal, wherein the second software instructions are configured to alter the mobile terminal to produce second observation data under at least one second parameter if the specific data characteristic is present, wherein at least one of the second parameter is different from the first parameter; and
receiving and processing the first and second observation data in a data handling agent.

9. The method of claim 8, wherein
the first parameter comprises at least one of:
an observation measurement interval for the first observational data, and
an observation measurement method for the first observational data,
and wherein the second parameter comprises at least one of:
an observation measurement interval for the second observational data, and
an observation measurement method for the second observational data.

10. The method of claim 8, wherein the first observation data and second observation data are produced by an observation logic configured on the mobile terminal.

11. The method of claim 10, wherein the first observation data and second observation data comprise at least one of behavioral, technical and contextual data exhibited on the mobile terminal.

12. The method of claim 8, wherein the second software instructions are configured to set a disabling parameter for producing second observation data, said disabling parameter being based on at least one of a time parameter and a mobile terminal event parameter.

13. The method of claim 12, wherein the second software instructions are configured to produce only first observation data under the at least one first parameter in the mobile terminal if the disabling parameter is met.

14. A computer program product, comprising a tangible computer usable medium having a computer readable program code embodied therein, said computer readable program code adapted to be executed to dynamically alter the collection of observation data produced on a mobile terminal, comprising:
configuring the mobile terminal to produce first observation data under at least one first parameter, wherein the first observation data comprises data relating to at least one of (i) a manner of usage and (ii) operating state of the mobile terminal;
determining, from the first observation data, if a specific data characteristic is present;
configuring the mobile terminal to produce second observation data under at least one second parameter if the specific data characteristic is present, wherein at least one of the second parameter is different from the first parameter.

15. The computer program product of claim 14, wherein the first parameter comprises at least one of:
an observation measurement interval for the first observational data and
an observation measurement method for the first observational data.

16. The computer program product of claim 15, wherein the second parameter comprises at least one of:
an observation measurement interval for the second observational data and
an observation measurement method for the second observational data.

17. The computer program product of claim 14, wherein the first observation data and second observation data are produced by an observation logic configured on the mobile terminal.

18. The computer program product of claim 17, wherein the first observation data and second observation data comprise at least one of behavioral, technical and contextual data exhibited on the mobile terminal.

19. The computer program product of claim 14, wherein configuring the mobile terminal to produce second observation data comprises setting a disabling parameter for producing second observation data, said disabling parameter being based on at least one of a time parameter and a mobile terminal event parameter.

20. The computer program product of claim 17, further comprising configuring the mobile terminal to produce only first observation data under the at least one first parameter if the disabling parameter is met.
